(19) United States
(12) Patent Application Publication
(10) Pub. No.: US 2019/0084485 A1
(43) Pub. Date: Mar. 21, 2019

(54) CARGO COMPARTMENT STORAGE DEVICE

(71) Applicant: FORD GLOBAL TECHNOLOGIES, LLC, Dearborn, MI (US)

(72) Inventors: Alejandra Rivas Franco, Mexico City (MX); Nathali Vasquez Henao, Ciudad de Mexico (MX); Jorge Arturo Ortiz Flores, Mexico City (MX); Mario Alejandro Medina Huerta, Mexico City (MX)

(21) Appl. No.: 15/705,485

(22) Filed: Sep. 15, 2017

(51) Int. Cl. B60R 7/02

(52) U.S. Cl. CPC B60R 7/02; B60R 2011/0036

(57) ABSTRACT

A cargo compartment storage device includes a drawer, a drawer guide for receiving the drawer and a flexible organizer depending from the drawer.

### TECHNICAL FIELD

This document relates generally to the motor vehicle equipment field and, more particularly, to a cargo compartment storage device that allows one to optimize use of the storage space in the cargo compartment.

### BACKGROUND

The space inside a storage compartment or trunk of a motor vehicle is relatively expansive and is not conducive to transporting small articles as acceleration forces, deceleration forces and cornering forces experienced during motor vehicle operation have a tendency to displace those items into each other and into the sidewalls of the cargo compartment. Many items, such as lightbulbs and eggs, are relatively fragile and prone to breaking when coming into contact with the sidewalls of the storage compartment or engaged with other heavier items that might be rolling or moving around in the cargo compartment. In addition, heavier items may engage a sidewall of the storage compartment with substantial force damaging those items or the trim of the storage compartment.

This document relates to a new and improved cargo compartment storage device that has the capability of separating and maintaining objects and items in a designated space within the storage compartment. Accordingly, transported items may be kept in an orderly fashion in specific places. The potential damage to items is significantly reduced or eliminated. Advantageously, the cargo compartment storage device allows for efficient and effective transportation of smaller cargo items under substantially any foreseeable operating conditions, allowing one to optimize the storage space for most any transport application.

### SUMMARY

In accordance with the purposes and benefits described herein, a cargo compartment storage device is provided. That cargo compartment storage device comprises a drawer, a drawer guide, receiving the drawer, and a flexible organizer depending from the drawer. The drawer may include a front wall, a rear wall, two sidewalls, a bottom wall and an open top. The flexible organizer may include a rear wall, two opposed sidewalls, a bottom wall and an open front wall. Further, the flexible organizer may be divided to include multiple compartments.

More specifically, the flexible organizer may include partition sections extending between the rear wall, the two opposed sidewalls and the bottom wall to divide the flexible organizer into those multiple compartments. Further, the flexible organizer may be displaceable between a stowed position, flat against the bottom wall of the drawer, and a deployed position depending downward from the drawer.

A fastening feature may be provided to releasably secure the flexible organizer in the stowed position. That fastening feature may comprise a first magnetic element secured to the drawer and a second, cooperating magnetic element carried on the bottom wall of the flexible organizer. In one or more of the many possible embodiments, the flexible organizer may be made from a fabric material.

The drawer guide of the cargo compartment storage device may include two guide tracks. Further, the drawer may include two followers that slide in the two guide tracks. Further, the multiple compartments may include a plurality of access openings wherein the open top of the drawer is oriented in a first plane and the plurality of openings for the storage compartments are oriented in a second plane wherein the first plane is perpendicular to the second plane. In a particularly useful embodiment, the drawer opening is provided in a horizontal plane and the access openings are provided in a vertical plane that is oriented toward the rear of the motor vehicle to allow easy access.

Advantageously, the drawer may be removed from the drawer guide if desired and utilized to carry items held therein to a desired location remote from the motor vehicle.

In the following description, there are shown and described several preferred embodiments of the cargo compartment storage device. As it should be realized, the cargo compartment storage device is capable of other, different embodiments and its several details are capable of modification in various, obvious aspects all without departing from the cargo compartment storage device as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the cargo compartment storage device and together with the description serve to explain certain principles thereof.

FIG. 1 is a perspective view of the cargo compartment/trunk of a motor vehicle equipped with the cargo compartment storage device. That device is illustrated in a presentation position wherein the drawer and flexible organizer depending from the drawer have been displaced rearwardly along the drawer guide to allow for easier access by an individual standing behind the motor vehicle.

FIG. 2a is an exploded perspective view of the cargo compartment storage device illustrated in FIG. 1.

FIG. 2b is a schematic view illustrating the shape of the compartments of the flexible organizer.

FIG. 3 is a detailed perspective view illustrating the flexible organizer of the cargo compartment storage device in a stowed position lying flat against the bottom wall of the drawer.

FIG. 4 is a view similar to FIG. 3 but showing the flexible organizer in a deployed position with the access openings for multiple compartments of that organizer oriented toward the viewer.

Reference will now be made in detail to the present preferred embodiments of the cargo compartment storage device, examples of which are illustrated in the accompanying drawing figures.

### DETAILED DESCRIPTION

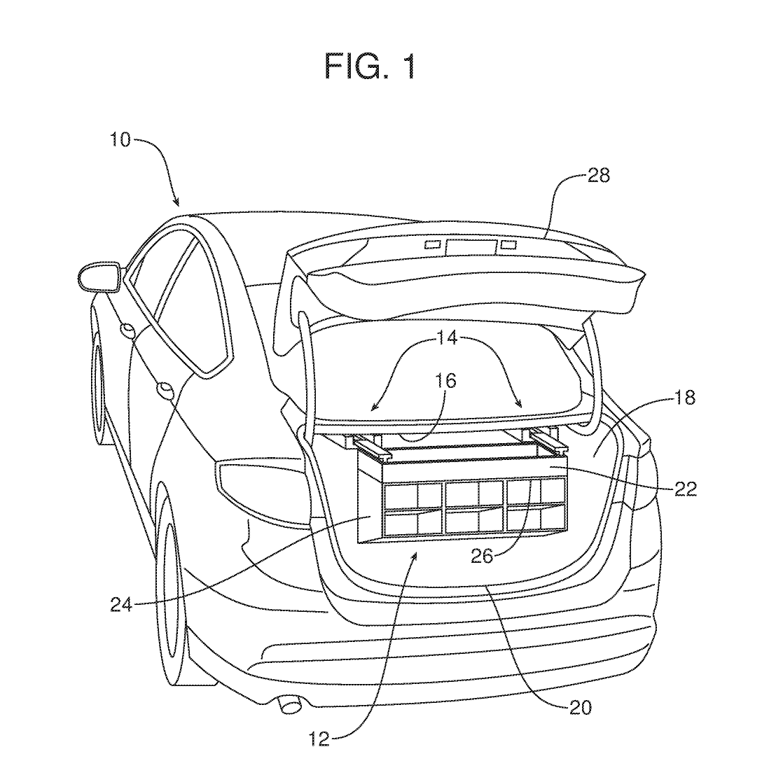

Reference is now made to FIG. 1 which illustrates a motor vehicle 10 equipped with the cargo compartment storage device 12. As illustrated in FIG. 1, the cargo compartment storage device 12 includes a drawer guide 14 fixed to the upper wall 16 of the cargo compartment 18 forward of the cargo compartment access opening 20.

The cargo compartment storage device 12 also includes a drawer 22 that slides in the drawer guide 14 and a flexible organizer 24 that depends from the bottom wall 26 of the drawer.

As illustrated in FIG. 1, the cargo compartment storage device 12 is in a deployed or presentation position wherein the drawer 22 and flexible organizer 24 project rearwardly from the drawer guide 14 toward the rear of the motor vehicle 10 allowing one at the rear of the motor vehicle to easily access the drawer and the flexible organizer when the truck lid 28 is opened.

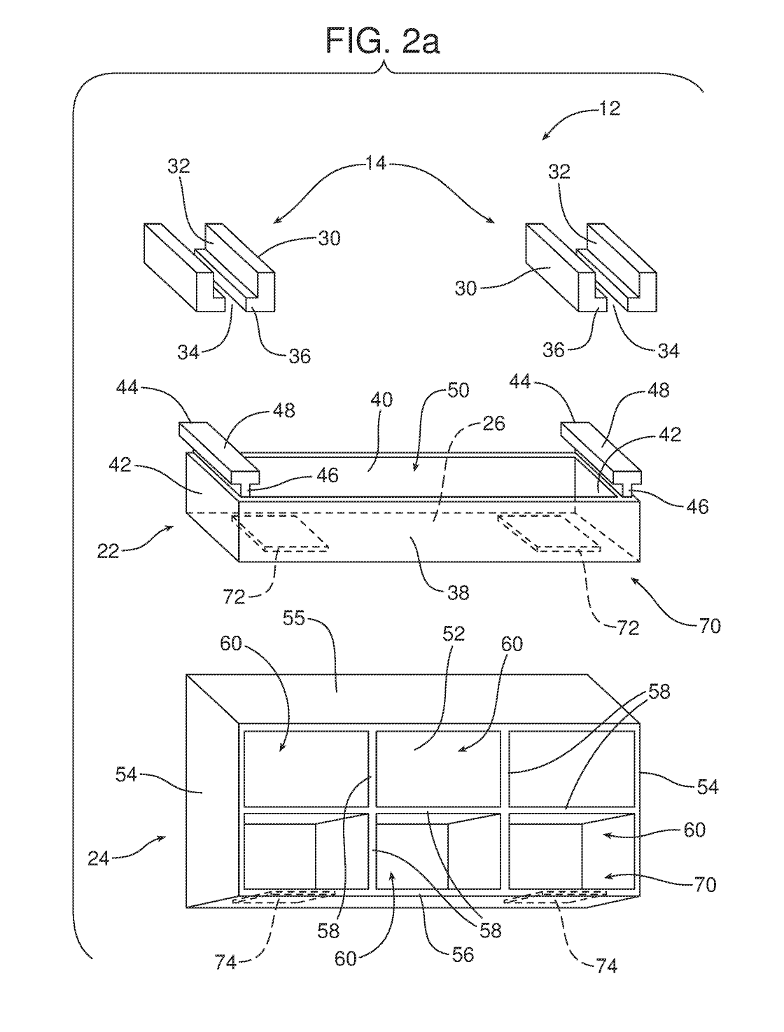

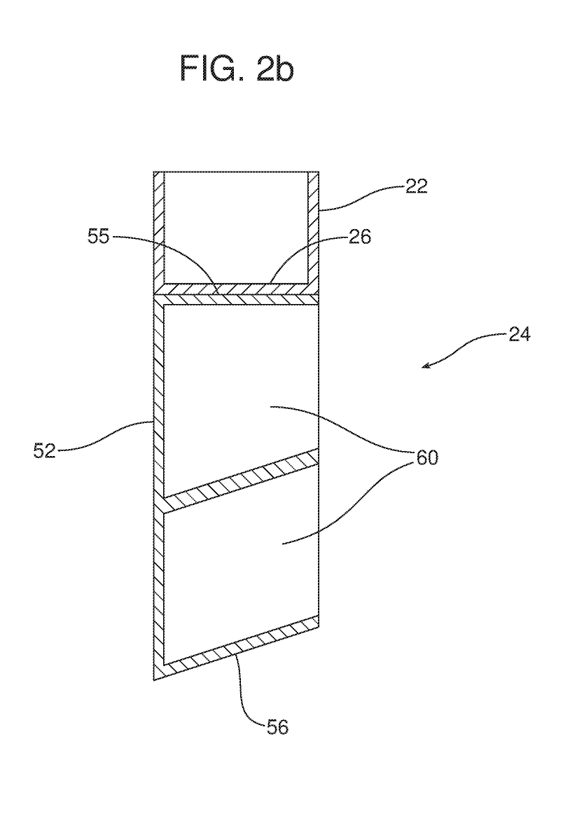

Reference is now made to FIGS. 2-4 which illustrate the cargo compartment storage device 12 in greater detail. As illustrated, the drawer guide 14 includes two guide tracks 30. Each guide track includes a channel 32. Each guide track also includes an open slot 34 in the bottom wall 36. That open slot is in communication with the channel 32.

The drawer 22 includes a front wall 38, a rear or back wall 40 and two sidewalls 42 in addition to the bottom wall 26. A guide track follower 44 is provided at the top of each sidewall 42. Each guide track follower 44 is substantially T-shaped. When the drawer 22 is operatively engaged with the drawer guide 14, the first section 46 of each guide track follower passes through an open slot 34 in the bottom wall 36 of a guide track 30 and the second section 48 of each guide track follower is received in the channel 32 of the guide track. Drawer compartment 50 defined by the bottom wall 26, front wall 38, rear wall 40 and two sidewalls 42 is easily accessed through the open top when the drawer is displaced rearwardly with respect to the drawer guide 14 as illustrated in FIG. 1.

The flexible organizer 24 includes a rear wall 52, two opposed sidewalls 54, a top wall 55, a bottom or lowermost wall 56 and partition sections 58. The top wall 55 and bottom wall 56 may include or comprise a rigid or semi-rigid substrate if desired. The partition sections 58 divide the flexible organizer 24 into multiple compartments 60 (six compartments are illustrated in drawing FIG. 2). The front of the flexible organizer 24 is open to allow one to easily access and utilize the compartments 60. The bottom walls of each compartment 60 are sloped in a manner to cause gravity to draw objects toward the rear wall 52 and the “bottom” of each compartment. See FIG. 2b. More specifically, as illustrated in the drawing figures, the open top of the drawer 22 is oriented in a first or horizontal plane P₁ while the open front of the flexible organizer in communication with the compartments 60 is oriented in a second, vertical plane P₂. Thus, in the illustrated embodiment the first plane is perpendicular to the second plane.

The flexible organizer 24 may be made from substantially any flexible material including fabric material such as nylon or nylon netting. Here it should also be appreciated that other materials may be utilized including, but not necessarily limited to security fabric, polystyrene and vinyl. The interface sections of the flexible organizer 24 may be stitched, glued and/or include reinforced stitches.

The drawer 22 may be made from a number of different materials including, but not necessarily limited to rubber and/or recycled rubber, injection molded plastic and even reinforced fabric comprising multiple layers with plastic reinforcement. The drawer guide 14 may also be made of similar materials.

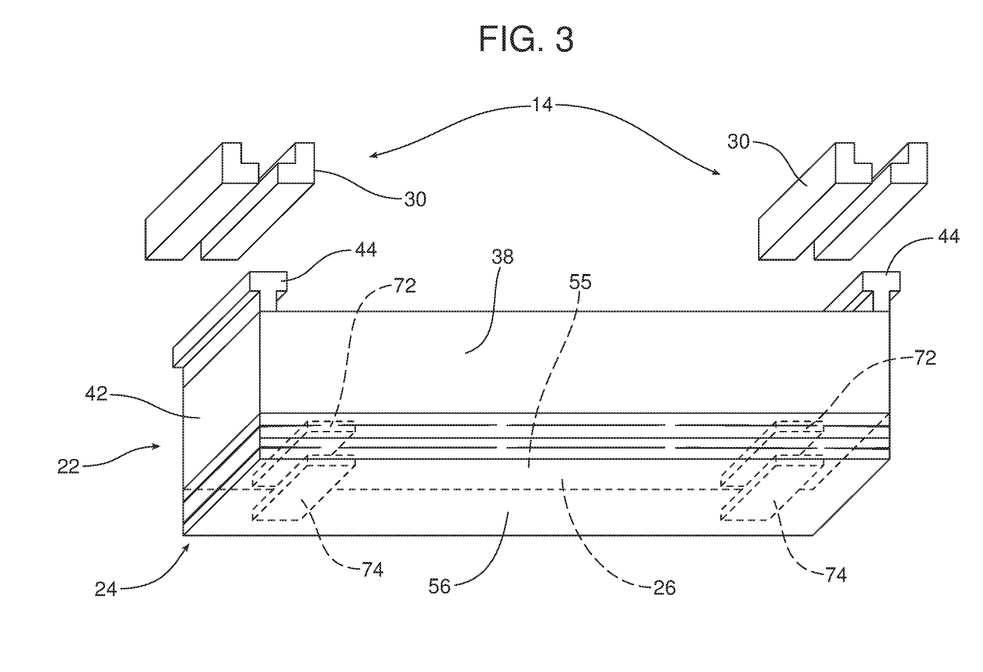

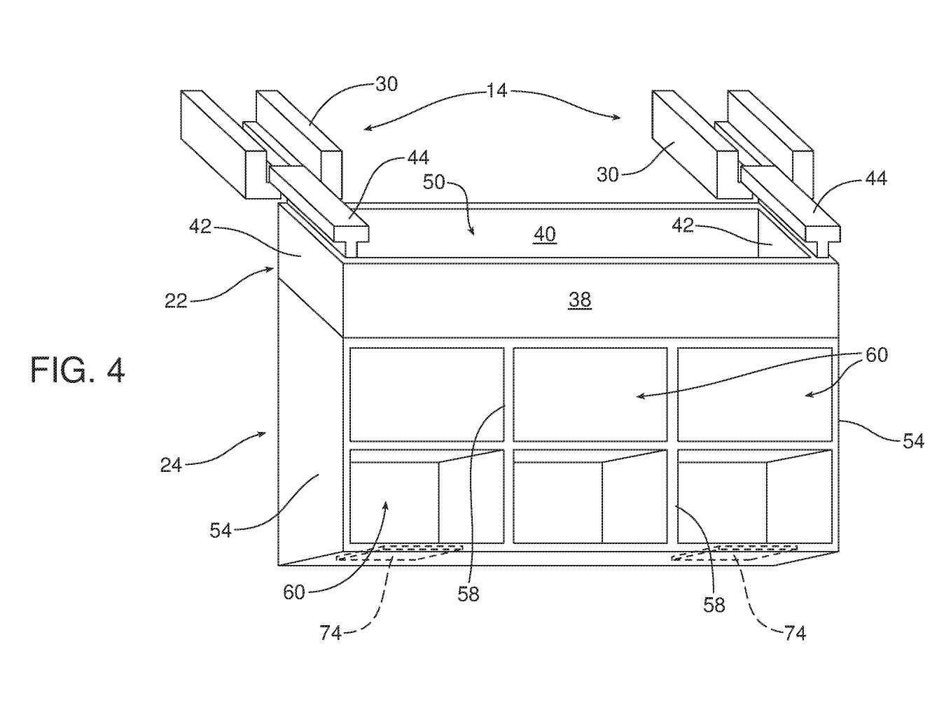

As should be appreciated from reviewing FIGS. 3 and 4, the flexible organizer 24 is displaceable between a stowed position, flat against the bottom wall 26 of the drawer 22 (see FIG. 3) and a deployed position depending downward from the drawer (see FIG. 4). A fastening feature 70 may be provided to releasably secure the flexible organizer 24 in the stowed position. In the illustrated embodiment, the fastening feature 70 comprises a first magnetic element 72 secured to the bottom wall 26 of the drawer 22 and a second, cooperating magnetic element 74 carried on the bottom wall 56 of the flexible organizer 24. When in the stowed position the first magnetic element 72 and second magnetic element 74 are positioned juxtaposed to one another and the flexible organizer 24 is held in the stowed position by the force of attraction between the two magnetic elements. When one desires to deploy the flexible organizer 24, one simply grabs the bottom wall 36 of the flexible organizer and pulls down, separating the first magnetic element 72 and the second magnetic element 74.

The flexible organizer provides a number of benefits and advantages. When the drawer 22 is pushed forward into the drawer guide 14 under the upper wall 16 of the cargo compartment 18, the cargo compartment access opening 20 is fully opened to receive cargo without any interference from the cargo compartment storage device 12. However, when one wishes to utilize the cargo compartment storage device 12 it may be displaced rearwardly on the drawer guide 14 so that the open top of the drawer 22 may be easily accessed. Of course, the open front 62 of the flexible organizer 24 is oriented rearward toward anyone standing behind the vehicle thereby making it very easy to insert or remove items in the individual compartments 60 of the flexible organizer. There those items are stowed and protected from rolling around or being engaged by other objects rolling around the cargo compartment 18 during operation of the motor vehicle.

It should also be appreciated that the drawer 22 may be easily removed by withdrawing the guide track followers 44 from the guide tracks 30. The contents of the drawer 22 and the flexible organizer 24, if deployed, may then be easily carried to a desired location remote from the motor vehicle. Further, it should be noted that the drawer 22 is always functional whether or not the flexible organizer 24 is in the stowed position or the deployed position.

The foregoing has been presented for purposes of illustration and description. It is not intended to be exhaustive or to limit the embodiments to the precise form disclosed. Obvious modifications and variations are possible in light of the above teachings. For example, a latch mechanism may be provided to hold the drawer 22 in any desired position within the drawer guide 14. Further, flaps may be provided to allow one to close the front wall of one or more of the compartments of the flexible organizer 24. In addition, a fastening feature 70 other than the cooperating magnetic elements 72, 74 may be used to secure the flexible organizer 24 to the bottom wall 26 of the drawer 22. For example, a hook and lop fastening device may be used. All such modifications and variations are within the scope of the appended claims when interpreted in accordance with the breadth to which they are fairly, legally and equitably entitled.

1. A cargo compartment storage device, comprising:
a drawer;
a drawer guide receiving said drawer; and
a flexible organizer depending from said drawer.

2. The cargo compartment storage device of claim 1, wherein said flexible organizer includes multiple compartments.

3. The cargo compartment storage device of claim 2, wherein said drawer includes a front wall, a back wall, two sidewalls and a bottom wall.

4. The cargo compartment storage device of claim 3, wherein said flexible organizer includes a rear wall, two opposed sidewalls, a lowermost wall and an open front wall.

5. The cargo compartment storage device of claim 4, wherein said flexible organizer includes partition sections extending between said rear wall, said two opposed sidewalls and said bottom wall, said partition sections dividing said flexible organizer into said multiple compartments.

6. The cargo compartment storage device of claim 5, wherein said flexible organizer is displaceable between a stowed position flat against said drawer and a deployed position depending downward from said drawer.

7. The cargo compartment storage device of claim 6, further including a fastening feature to releasably secure said flexible organizer in said stowed position.

8. (canceled)

9. The cargo compartment storage device of claim 13, wherein said flexible organizer is made from a fabric material.

10. The cargo compartment storage device of claim 1, wherein said drawer includes two guide tracks.

11. The cargo compartment storage device of claim 10, wherein said drawer includes two followers that slide in said two guide tracks.

12. The cargo compartment storage device of claim 2, wherein said drawer includes an open top and said multiple compartments include a plurality of access openings wherein said open top is oriented in a first plane and said plurality of access openings are oriented in a second plane wherein said first plane is perpendicular to said second plane.

13. A cargo compartment storage device, comprising:
a drawer including a front wall, a back wall, two sidewalls and a bottom wall;
a drawer guide receiving said drawer;
a flexible organizer depending from said drawer, said flexible organizer including a rear wall, two opposed sidewalls, a lowermost wall, an open front wall and partition sections extending between said rear wall, said two opposed sidewalls and said lowermost wall, said partition sections dividing said flexible organizer into multiple compartments, said flexible organizer being displaceable between a stowed position flat against said drawer and a deployed position depending downward from said drawer; and
a fastening feature releasably securing said flexible organizer in said stowed position, said fastening feature including a first magnetic element secured to said drawer and a second cooperating magnetic element carried on said lowermost wall of said flexible organizer.
